(19) United States
(12) Patent Application Publication
(10) Pub. No.: US 2022/0032312 A1
(43) Pub. Date: Feb. 3, 2022

(54) STIRRING APPARATUS AND STIRRING METHOD

(71) Applicant: SEIKO EPSON CORPORATION, Tokyo (JP)

(72) Inventors: Koji MOTOHASHI, Matsumoto (JP); Makoto SATO, Matsumoto (JP); Takashi ABE, Sakata (JP)

(21) Appl. No.: 17/386,613

(22) Filed: Jul. 28, 2021

(30) Foreign Application Priority Data
Jul. 30, 2020 (JP) 2020-129166

(51) Int. Cl. B02C 18/16; B02C 18/00; B01F 7/00; B01F 7/16; B01F 5/12

(52) U.S. Cl. CPC B02C 18/16; B02C 18/0007; B01F 7/00291; B01F 2215/0078; B01F 7/162; B01F 5/12; B01F 7/00616

(57) ABSTRACT

A stirring apparatus includes a shredder that shreds a sheet; a case that accommodates a sheet piece shredded by the shredder and has a bottom surface and an inner surface; and a rotator that is disposed at the bottom surface of the case and includes a blade which stirs the sheet piece by rotation, in which L1<L3<L2, when between an outer end of the blade and the inner surface in a radial direction of the rotator, a shortest distance in the radial direction is defined as L1, a longest distance in the radial direction is defined as L2, and an average major axis length of the sheet piece is defined as L3.

The present application is based on, and claims priority from JP Application Serial Number 2020-129166, filed Jul. 30, 2020, the disclosure of which is hereby incorporated by reference herein in its entirety.

### BACKGROUND

### 1. Technical Field

The present disclosure relates to a stirring apparatus and a stirring method.

### 2. Related Art

JP-A-2011-241497 discloses a waste paper recycling apparatus that recycles waste paper. This waste paper recycling apparatus includes a paper feeding portion that includes a paper material storage apparatus for storing a cut paper material, a measurement portion that measures the paper material supplied from the paper feeding portion, and a pulper apparatus that produces a pulp suspension from the paper material weighed by the measurement portion. Further, the paper material storage apparatus includes a storage container for storing the cut paper material and a stirring apparatus for stirring the paper material stored in the storage container.

The stirring apparatus includes a rotary shaft provided on a bottom plate of the storage container and a rotatable stirring member provided on an upper end of the rotary shaft. When the stirring member rotates, the paper material in the storage container is stirred and moved outward in a radial direction of the rotary shaft by centrifugal force. The paper material is discharged from an outlet of the storage container.

The stirring member described in JP-A-2011-241497 has a problem that sheet pieces stored in a case (the storage container) cannot be sufficiently stirred due to a quantity of the sheet pieces (the paper material).

### SUMMARY

According to an aspect of the present disclosure, there is provided a stirring apparatus including: a shredder that shreds a sheet; a case that accommodates a sheet piece shredded by the shredder and has a bottom surface and an inner surface; and a rotator that is disposed at the bottom surface of the case and includes a blade which stirs the sheet piece by rotation, in which L1<L3<L2, when between an outer end of the blade and the inner surface in a radial direction of the rotator, a shortest distance in the radial direction is defined as L1, a longest distance in the radial direction is defined as L2, and an average major axis length of the sheet piece is defined as L3.

According to another aspect of the present disclosure, there is provided a stirring method of stirring a sheet piece by using an apparatus including a case that accommodates the sheet piece and has a bottom surface and an inner surface; and a rotator that is disposed at the bottom surface of the case and includes a blade, in which L1<L3<L2, when between an outer end of the blade and the inner surface in a radial direction of the rotator, a shortest distance in the radial direction is defined as L1, a longest distance in the radial direction is defined as L2, and an average major axis length of the sheet piece is defined as L3.

### BRIEF DESCRIPTION OF THE DRAWINGS

FIG. 1 is a diagram illustrating a configuration of a sheet manufacturing apparatus.

FIG. 2 is a perspective view illustrating a shredder in FIG. 1.

FIG. 3 is a diagram illustrating an operation state in order when a main portion of the shredder in FIG. 2 is seen from a direction of an arrow III.

FIG. 4 is a conceptual diagram illustrating a mode in which a raw material sheet is shredded in accordance with the operation illustrated in FIG. 3.

FIG. 5 is a perspective view illustrating a storage portion in FIG. 1.

FIG. 6 is a longitudinal perspective view taken along line the VI-VI in FIG. 5.

FIG. 7 is a longitudinal cross-sectional view taken along the line VII-VII in FIG. 5.

FIG. 8 is a plan view schematically illustrating a stirring portion in FIG. 5.

FIG. 9 is a schematic diagram illustrating a principle of stirring in the stirring portion illustrated in FIG. 8.

FIG. 10 is a schematic view illustrating a longitudinal cross-section of the stirring portion illustrated in FIG. 8.

FIG. 11 is a plan view illustrating a storage portion of a stirring apparatus according to a first modification example.

FIG. 12 is a plan view illustrating a storage portion of a stirring apparatus according to a second modification example.

### DESCRIPTION OF EXEMPLARY EMBODIMENTS

Hereinafter, a stirring apparatus and a stirring method according to the present disclosure will be described in detail based on embodiments illustrated in the accompanying drawings.

### 1. Sheet Manufacturing Apparatus

First, a sheet manufacturing apparatus including a stirring apparatus will be described.

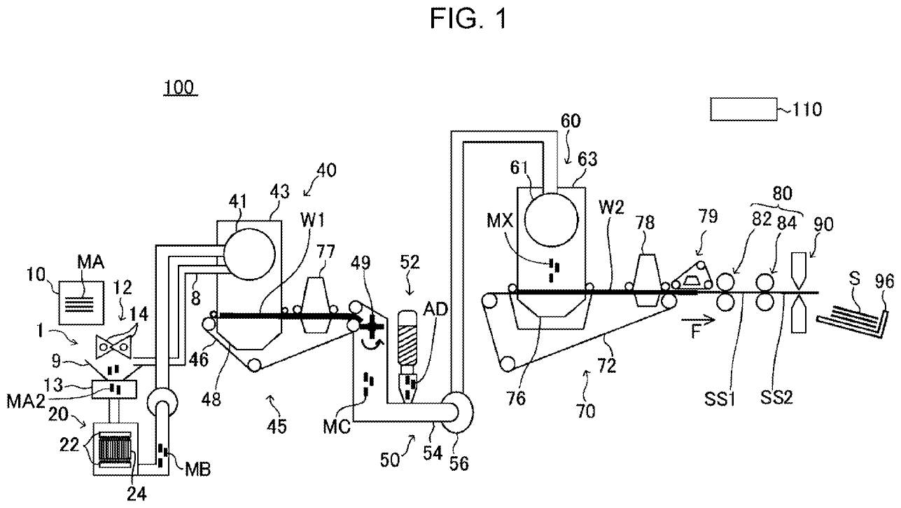

FIG. 1 is a diagram illustrating a configuration of a sheet manufacturing apparatus 100.

The sheet manufacturing apparatus 100 manufactures a sheet S by fiberizing a raw material sheet MA containing fibers such as a wood-based pulp material or kraft pulp, waste paper, and synthetic pulp.

The sheet manufacturing apparatus 100 includes a supply portion 10, a shredder 12, a storage portion 13, a defibration portion 20, a sorting portion 40, a first web forming portion 45, a rotator 49, a mixing portion 50, a dispersion portion 60, a second web forming portion 70, a web transport portion 79, a processing portion 80, and a cutting portion 90.

The supply portion 10 supplies the raw material sheet MA to the shredder 12. The shredder 12 is a shredder which cuts the raw material sheet MA by a shredding blade 14. The raw material sheet MA is cut into a piece of paper by the shredder 12, and becomes a sheet piece MA2. The sheet piece MA2 is collected by a hopper 9 and transported to the storage portion 13.

The storage portion 13 temporarily stores the sheet piece MA2 supplied from the shredder 12 and supplies a predetermined quantity of sheet pieces MA2 to the defibration portion 20. As a result, it possible to hold the predetermined quantity of sheet pieces MA2 supplied for a manufacturing step of the sheet S.

The defibration portion 20 defibrates the fine piece cut by the shredder 12 in a dry method to obtain a defibrated material MB. The defibration is a process of unraveling the sheet piece MA2 in a state in which a plurality of fibers are bound into one or a small number of fibers. The dry method refers to performing a process such as defibration in the air, instead of in a liquid. For example, the defibrated material MB contains components derived from the sheet piece MA2, such as fibers contained in the sheet piece MA2, resin particles, coloring agents such as ink or toner, anti-smearing materials, and paper strength enhancers.

The defibration portion 20 is, for example, a mill which includes a tube-shaped stator 22 and a rotor 24 which rotates inside the stator 22, and defibrates the shredded piece by sandwiching the shredded piece between the stator 22 and the rotor 24. The defibrated material MB is sent to the sorting portion 40 through a pipe.

The sorting portion 40 includes a drum portion 41 and a housing portion 43 which accommodates the drum portion 41. The drum portion 41 is a sieve having openings such as a net, a filter, and a screen, and is rotated by power of a motor (not illustrated). The defibrated material MB unravels inside the rotating drum portion 41 and descends through the opening of the drum portion 41. Among components of the defibrated material MB, a component which does not pass through the opening of the drum portion 41 is transported to the hopper 9 through a pipe 8.

The first web forming portion 45 includes an endless-shaped mesh belt 46 having a large number of openings. The first web forming portion 45 manufactures a first web W1 by accumulating fibers and the like descending from the drum portion 41 on the mesh belt 46. Among the components descending from the drum portion 41, a component smaller than the opening of the mesh belt 46 passes through the mesh belt 46 and are suctioned and removed by a suction portion 48. Thus, among the components of the defibrated material MB, short fibers, resin particles, ink, toner, anti-smearing agents, and the like, which are not appropriate for manufacturing the sheet S, are removed.

A humidifier 77 is disposed at a movement path of the mesh belt 46, and the first web W1 accumulated on the mesh belt 46 is humidified by mist-like water or high-humidity air.

The first web W1 is transported by the mesh belt 46 and comes into contact with the rotator 49. The rotator 49 divides the first web W1 by a plurality of blades to obtain a material MC. The material MC is transported to the mixing portion 50 through a pipe 54.

The mixing portion 50 includes an additive supply portion 52 which adds an additive material AD to the material MC, and a mixing blower 56 which mixes the material MC and the additive material AD. The additive material AD includes a binding material such as a resin for binding a plurality of fibers, and may include coloring agents, an aggregation inhibitor, a flame retardant, and the like. The mixing blower 56 generates airflow in the pipe 54 to which the material MC and the additive material AD are transported, mixes the material MC and the additive material AD, and transports a mixture MX to the dispersion portion 60.

The dispersion portion 60 includes a drum portion 61 and a housing 63 which accommodates the drum portion 61. The drum portion 61 is a cylinder-shaped sieve having the same configuration as the drum portion 41, and is driven by a motor (not illustrated) to rotate. By the rotation of the drum portion 61, the mixture MX unravels and descends into the housing 63.

The second web forming portion 70 includes an endless-shaped mesh belt 72 having a large number of openings. The second web forming portion 70 manufactures a second web W2 by accumulating the mixture MX descending from the drum portion 61 on the mesh belt 72. Among components of the mixture MX, those smaller than the opening of the mesh belt 72 pass through the mesh belt 72 and are suctioned by a suction portion 76.

A humidifier 78 is disposed at a movement path of the mesh belt 72, and the second web W2 accumulated on the mesh belt 72 is humidified by mist-like water or high-humidity air.

The second web W2 is peeled off from the mesh belt 72 by the web transport portion 79, and is transported to the processing portion 80. The processing portion 80 includes a pressing portion 82 and a heating portion 84. The pressing portion 82 sandwiches the second web W2 between a pair of pressing rollers and presses the second web W2 with a predetermined nip pressure to form a pressurized sheet SS1. The heating portion 84 applies heat across the pressurized sheet SS1 by a pair of heating rollers. Thus, fibers contained in the pressurized sheet SS1 are bound by resin contained in the additive material AD, and a heated sheet SS2 is formed. The heated sheet SS2 is transported to the cutting portion 90.

The cutting portion 90 cuts the heated sheet SS2 in at least one direction of a direction crossing a transport direction F and a direction along the transport direction F, and manufactures a sheet S having a predetermined size. The sheet S is stored in a discharge portion 96.

The sheet manufacturing apparatus 100 includes a control apparatus 110. The control apparatus 110 controls an operation of each portion of the sheet manufacturing apparatus 100 including the defibration portion 20, the additive supply portion 52, the mixing blower 56, the dispersion portion 60, the second web forming portion 70, the processing portion 80, and the cutting portion 90 so as to execute a method of manufacturing the sheet S. Further, the control apparatus 110 may control the operations of the supply portion 10, the sorting portion 40, the first web forming portion 45, and the rotator 49.

### 2. Stirring Apparatus

Next, a stirring apparatus 1 according to the present embodiment will be described.

The stirring apparatus 1 illustrated in FIG. 1 includes the shredder 12 and the storage portion 13. The stirring apparatus 1 cuts the raw material sheet MA into the sheet pieces MA2 by the shredder 12, and transports the sheet piece MA2 to the storage portion 13. In the storage portion 13, the sheet piece MA2 is temporarily stored, and a predetermined quantity of sheet pieces MA2 is supplied to the defibration portion 20 while stirring the sheet pieces MA2. Hereinafter, the respective portions will be sequentially described.

### 2.1. Shredder

The shredder 12 is a shredder which cuts the raw material sheet MA by the shredding blade 14.

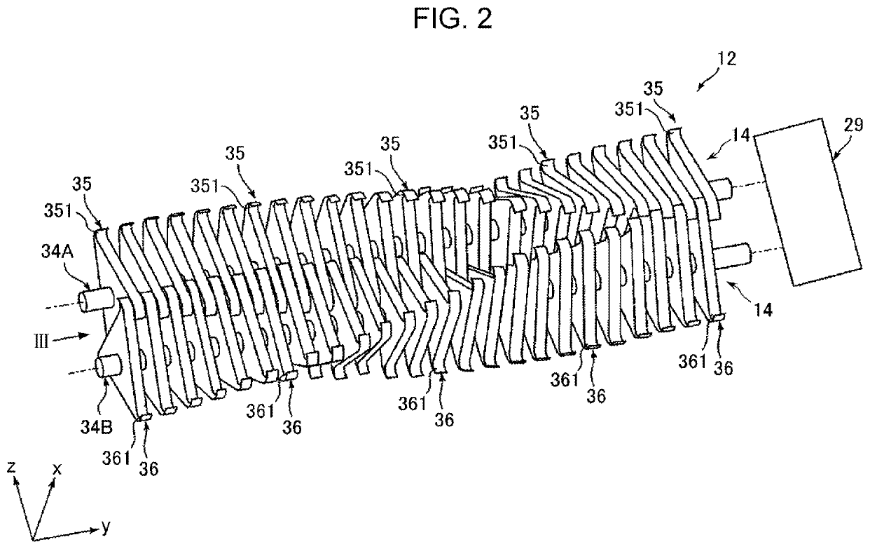

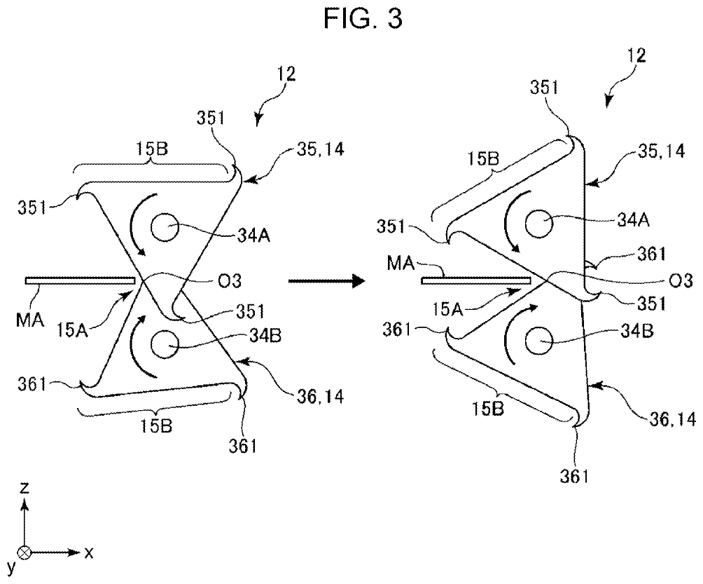

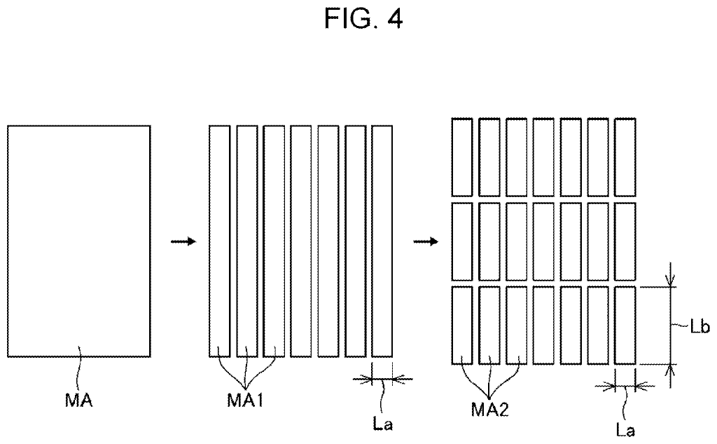

FIG. 2 is a perspective view illustrating the shredder 12 in FIG. 1. FIG. 3 is a diagram illustrating an operation state in order when a main portion of the shredder 12 in FIG. 2 is seen from a direction of an arrow III. FIG. 4 is a conceptual diagram illustrating a mode in which the raw material sheet MA is shredded in accordance with the operation illustrated in FIG. 3. In FIGS. 2 and 3, an x-axis, a y-axis, and a z-axis that are orthogonal to each other are set. A direction in which the arrow of each axis point is called “+”, and an opposite direction is called “−”.

The shredder 12 illustrated in FIG. 2 includes the two shredding blades 14 and a driving portion 29 that drives the two shredding blades 14. Of the two shredding blades 14, one shredding blade 14 includes a plurality of first rotary blades 35 and a first shaft 34A disposed in parallel with the y-axis. The other shredding blade 14 includes a plurality of second rotary blades 36 and a second shaft 34B disposed in parallel with the y-axis.

The plurality of first rotary blades 35 are rotatably supported by the first shaft 34A. The plurality of second rotary blades 36 are rotatably supported by the second shaft 34B.

The first shaft 34A and the second shaft 34B are supported by both sides, and one end sides of the first shaft 34A and the second shaft 34B are coupled to the driving portion 29. As illustrated in FIG. 3, the driving portion 29 rotates the first shaft 34A and the second shaft 34B in opposite directions to each other. Thus, the first rotary blade 35 and the second rotary blade 36 also rotate in opposite directions to each other.

The plurality of first rotary blades 35 are arranged at equal intervals along the y-axis, on the first shaft 34A. Each first rotary blade 35 is configured with a plate member, and the first shaft 34A is inserted through a center portion of the first rotary blade 35.

The plurality of second rotary blades 36 are arranged at equal intervals along the y-axis, on the second shaft 34B. Each second rotary blade 36 is configured with a plate member, and the second shaft 34B is inserted through a center portion of the second rotary blade 36.

The first rotary blade 35 and the second rotary blade 36 are arranged so as to alternately overlap along the y-axis. When each first rotary blades 35 and each second rotary blade 36 rotate, the raw material sheet MA is cut at a plurality of locations between the adjacent first rotary blade 35 and second rotary blade 36 in a direction orthogonal to the y-axis. As a result, as illustrated in FIG. 4, the raw material sheet MA is divided into strip pieces MA1 having a width La corresponding to a thickness of the first rotary blade 35 and the second rotary blade 36. That is, a plurality of strip pieces MA1 can be obtained from the raw material sheet MA. The width La of the strip piece MA1 means a length of a short axis orthogonal to a long axis of the strip piece MA1.

The number of the first rotary blade 35 and the second rotary blade 36 to be arranged is not particularly limited as long as the plurality of first rotary blade 35 and second rotary blade 36 are provided. Further, the thickness of the first rotary blade 35 and the thickness of the second rotary blade 36 may be the same as or different from each other.

The thickness of the first rotary blade 35 and the second rotary blade 36 is not particularly limited, and may be equal to or more than 1 mm and equal to or less than 10 mm, and more appropriately equal to or more than 2 mm and equal to or less than 5 mm, for example.

Shapes of the first rotary blade 35 and the second rotary blade 36 when seen from a y-axis direction are, for example, polygons and are not particularly limited, and in FIG. 3, the shape is substantially triangular. When the first rotary blade 35 and the second rotary blade 36 having such a shape rotate, an intersection O3 repeatedly appears with the rotation. Among points at which an outer edge of the first rotary blade 35 and an outer edge of the second rotary blade 36 apparently intersect with each other when seen from the y-axis direction, the intersection O3 means a point located in a direction in which the raw material sheet MA is put into. The intersection O3 moves in a +x-axis direction with the rotation of the first rotary blade 35 and the second rotary blade 36, that is, with a change from a state illustrated in the left part to a state illustrated in the right part in FIG. 3, and pulls in the raw material sheet MA.

A sharp first claw 351 is provided at the vicinity of a vertex of the first rotary blade 35 having a substantially triangular shape. Therefore, the three first claws 351 are provided in one first rotary blade 35.

In the same manner, a sharp second claw 361 is provided at the vicinity of a vertex of the second rotary blade 36 having a substantially triangular shape. Therefore, the three second claws 361 are provided in one second rotary blade 36.

Each time the first claw 351 and the second claw 361 collide with the strip piece MA1 illustrated in FIG. 4, the first claw 351 and the second claw 361 cut the strip piece MA1 in a direction intersecting a longitudinal direction of the strip piece MA1. Thus, as illustrated in FIG. 4, the sheet piece MA2 having a short strip shape is obtained. A length Lb of the sheet piece MA2 is substantially equal to a distance between the first claws 351 or a distance between the second claws 361. Therefore, the sheet piece MA2 has a substantially rectangular shape having the width La and the length Lb. Such a sheet piece MA2 has a shape and a dimension appropriate for stirring by a stirring portion 130. The length Lb of the sheet piece MA2 means a length of the sheet piece MA2 in the same direction as a long axis direction of the strip piece MA1 illustrated in FIG. 4.

Therefore, as illustrated in FIG. 3, the shredder 12 according to the present embodiment includes a first cutting portion 15A that cuts the raw material sheet MA into the strip piece MA1 having the width La, and a second cutting portion 15B that cuts the strip piece MA1 into the sheet piece MA2 having the length Lb.

The first cutting portion 15A cuts the raw material sheet MA with a width corresponding to any one of the thickness of the first rotary blade 35 or the thickness of the second rotary blade 36, which is a length in a depth direction on page in FIG. 3. Thus, the strip piece MA1 having the width La is obtained from the raw material sheet MA.

The second cutting portion 15B cuts the raw material sheet MA with a length corresponding to the distance between the first claws 351 or the distance between the second claws 361 in FIG. 3. Thus, the sheet piece MA2 having the length Lb is obtained from the strip piece MA1.

The configuration of the driving portion 29 is not particularly limited, and may include, for example, a motor and a speed reducer having a plurality of gears that mesh with each other. The driving portion 29 may be configured to rotate the first shaft 34A and the second shaft 34B collectively at the same rotation speed, or may be configured to rotate the first shaft 34A and the second shaft 34B at different rotation speeds.

Although the shredder 12 is described above, the configuration of the shredder 12 is not limited to the above configuration as long as the first cutting portion 15A and the second cutting portion 15B are provided. For example, the shredder 12 may not produce the fixed-shaped sheet piece MA2, and may produce an amorphous sheet piece. Specifically, a shredder including a tearing mechanism that cuts a raw material sheet so as to tear the raw material sheet off can be provided as an example. Thus, it is possible to cut the raw material sheet while leaving fibers contained in a sheet piece. Therefore, by using the sheet piece produced by the shredder including the tearing mechanism, a strength of the sheet S after recycling can be increased.

### 2.2. Storage Portion

Next, a configuration of the storage portion 13 will be described.

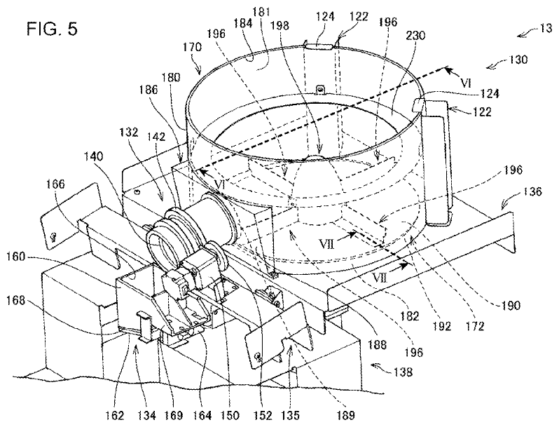

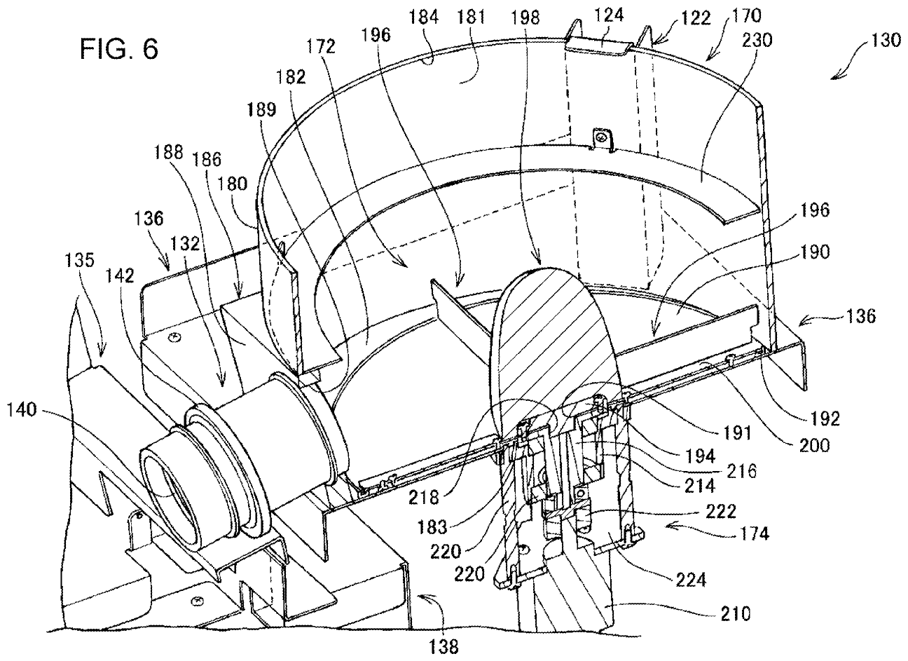

FIG. 5 is a perspective view illustrating the storage portion 13 in FIG. 1. FIG. 6 is a longitudinal cross-section perspective view taken along line the VI-VI in FIG. 5. In FIG. 5, only a part of a support member 122 is illustrated, and other illustrations are omitted.

### 2.2.1. Configuration Overview

The storage portion 13 according to the present embodiment includes the stirring portion 130, a discharge pipe 132, and a measurement portion 134.

The stirring portion 130 is provided on an upper surface of a mounting table 136, and temporarily stores inside and stirs the sheet piece MA2 transported from the shredder 12 via the hopper 9. The stirring portion 130 includes a case 170, a rotator 172, and a drive mechanism 174, as illustrated in FIG. 6.

The case 170 is a cylinder-shaped member for accommodating the sheet piece MA2 put into from the hopper 9, and the case 170 is formed by mounting a side wall 180 on the mounting table 136.

The side wall 180 is fixed to the mounting table 136 by being supported by a plurality of support members 122. As illustrated in FIG. 6, the support member 122 is a member formed so that a flat plate member has three surfaces. The respective support member 122 are arranged at the upper surface of the mounting table 136, and all the support member 122 extend in an upward-downward direction along the side wall 180. In FIG. 6, only a part of the support member 122 is illustrated, and other illustrations are omitted.

A claw portion 124 is provided at an upper end of each support member 122, and each claw portion 124 engages with an upper end of the side wall 180, so that the side wall 180 is fixed to the mounting table 136.

An overhanging portion 230 is provided on an inner surface 181 of the side wall 180 over an entire circumferential direction. The overhanging portion 230 is an annular-shaped flat plate member, and the overhanging portion 230 is supported by the plurality of support members 122 provided along an outer surface of the side wall 180.

The overhanging portion 230 is fixed to each support member 122 by a screw member via the side wall 180. That is, the side wall 180 is fixed to each support member 122 by the screw member together with the overhanging portion 230.

In the present embodiment, the overhanging portion 230 is fixed so as to be located at a height dimension of substantially half of a height dimension of the side wall 180.

By providing the overhanging portion 230, when the sheet piece MA2 put inside the stirring portion 130 is stirred, it is possible to prevent the sheet piece MA2 from being rolled up by the overhanging portion 230, and to prevent the sheet piece MA2 from overflowing from an opening portion 184.

The side wall 180 and the overhanging portion 230 may be integrally formed. Further, a height at which the overhanging portion 230 is provided or an overhanging length of the overhanging portion 230 may be adjusted according to a shape or a size of the stirring portion 130 and a processing speed. The overhanging portion 230 may be provided as needed and may be omitted.

A bottom surface 182 of the case 170 is the upper surface of the mounting table 136 surrounded by the side wall 180. When seen in top view of the bottom surface 182, a bottom surface hole 183, which is a through-hole, is provided at a location corresponding to a center of a rotating portion 190, which will be described below. The bottom surface 182 of the case 170 may be configured with a member provided separately from the upper surface of the mounting table 136.

The opening portion 184 is provided at an upper end of the case 170. The hopper 9 is disposed above the opening portion 184, that is, in a direction away from the bottom surface 182 of the case 170. The sheet piece MA2 can be put inside the case 170 from the hopper 9 through the opening portion 184.

A discharge portion 186 is provided on the side wall 180 of the case 170. The discharge portion 186 is a box-shaped member provided so as to project outward from below the side wall 180 facing the measurement portion 134. Further, the discharge portion 186 is provided so as to project inward from the inner surface 181 of the side wall 180. This overhanging portion is referred to as an “inner wall member 187”. Since the inner wall member 187 is overhanging, an inner diameter of the case 170 is shortened by the amount of the inner wall member 187 overhanging. The inner wall member 187 may be a part of the discharge portion 186 or may be a separate member. In the latter case, the inner wall member 187 may be attached to any position on the case 170. A shape of the inner wall member 187 is not limited to the shape as illustrated.

An inclined surface 188 is provided at a position facing the measurement portion 134, in the discharge portion 186. The inclined surface 188 is slopingly provided to approach the measurement portion 134 in an upward direction.

An outlet 189 that communicates an inside and an outside of the case 170 is provided in the discharge portion 186. The sheet piece MA2 stored inside the case 170 is discharged to the outside of the case 170 via the outlet 189.

The rotator 172 is a member rotatably provided with respect to the bottom surface 182, and the rotator 172 stirs the sheet pieces MA2 put into the case 170. The rotator 172 includes the rotating portion 190, a sealing member 192, a plurality of blades 196, and a protrusion member 198.

The rotating portion 190 is a disc-shaped member having a diameter smaller than a diameter of the bottom surface 182, and the rotating portion 190 is disposed so as to be parallel to the bottom surface 182, at a predetermined distance from the side wall 180 so that a peripheral edge does not come into contact with the side wall 180.

A center of the rotating portion 190 when seen in top view is disposed at a position different from a center of the bottom surface 182 when seen in top view. Specifically, the center of the rotating portion 190 when seen in top view is disposed at a position far from the discharge portion 186 in a radial direction of the rotating portion 190, with respect to the center of the bottom surface 182 when seen in top view.

A center hole 191, which is a through-hole, is provided at a rotation center of the rotating portion 190. The rotating portion 190 is rotatably supported by the drive mechanism 174, which will be described below.

The sealing member 192 is a member that closes between the rotating portion 190 and the bottom surface 182, and the sealing member 192 is provided over the entire peripheral edge of the rotating portion 190. As a result, when the sheet piece MA2 is put into the case 170, the sheet piece MA2 is prevented from entering between the rotating portion 190 and the bottom surface 182. Therefore, it is possible to prevent the sheet pieces MA2 from being compressed and becoming lumpy between the rotating portion 190 and the bottom surface 182.

In the present embodiment, the sealing member 192 is formed of, for example, a resin such as polyacetal.

The plurality of blades 196 are members that stir the sheet pieces MA2 with the rotation of the rotator 172, and all of these blades 196 are arranged at a virtual line extending radially from the rotation center of the rotating portion 190, on an upper surface of the rotating portion 190. In the present embodiment, the four blades 196 are provided at predetermined intervals in a circumferential direction of the rotating portion 190, in the rotator 172.

A flange 200 substantially orthogonal to the blade 196 is formed at a lower end edge of each blade 196. Each blade 196 is fixed by being screwed by a screw member or the like so that the flange 200 is in surface contact with the upper surface of the rotating portion 190.

A height dimension of each blade 196 is formed to be smaller than a caliber dimension of the outlet 189. As a result, a sufficient space is provided above the rotator 172 inside the case 170, and the sheet pieces MA2 are sufficiently stirred by the rotation of the rotator 172.

In the present embodiment, the blade 196 is erected substantially vertically, and an angle formed by the blade 196 and the upper surface of the rotating portion 190 is not limited to the vertical angle, and may be an acute angle or an obtuse angle.

An end portion of each blade 196 located on a center side of the rotator 172 is disposed at a position close to a coupling member 194, and an end portion of each blade 196 located on an outer peripheral side of the rotator 172 is disposed at a peripheral edge of the rotating portion 190. That is, a longitudinal direction of each blade 196 extends from the vicinity of the rotation center of the rotating portion 190 to the peripheral edge. As a result, when the rotator 172 rotates, the sheet piece MA2 put into the case 170 can be stirred over a wider range in a radial direction of the case 170.

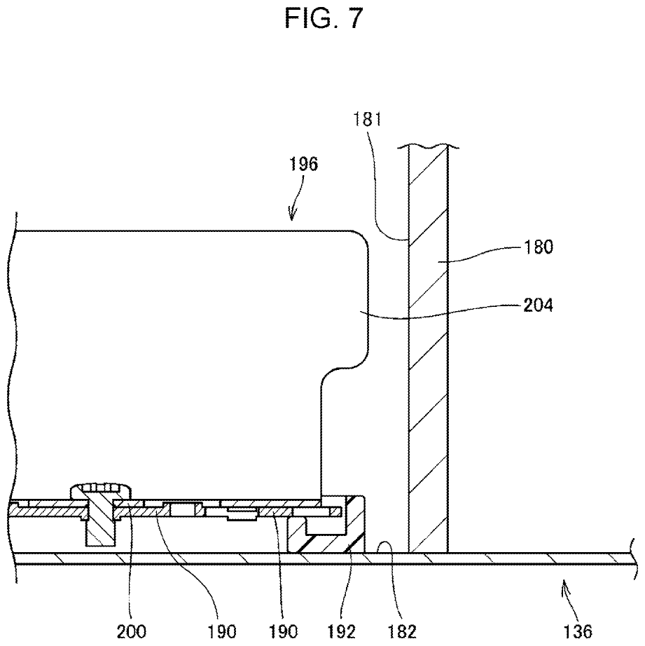

FIG. 7 is a longitudinal cross-sectional view taken along the line VII-VII in FIG. 5.

As illustrated in FIG. 7, a projecting piece 204 projecting outward in a radial direction of the rotating portion 190 is provided on an outer peripheral side edge of the blade 196. The projecting piece 204 is provided above the outer peripheral edge of the blade 196, and at least a part of the projecting piece 204 is disposed at a position being overlapped with the outlet 189, in a height direction of the case 170, when seen in side view of the case 170.

As a result, when the blade 196 stirs the sheet pieces MA2, the blade 196 can push the sheet piece MA2 into the outlet 189 illustrated in FIGS. 5 and 6, and the sheet pieces MA2 can be more efficiently sent from the outlet 189 to the discharge pipe 132.

As illustrated in FIG. 6, the protrusion member 198 is a member disposed at a rotation center on the upper surface of the rotating portion 190, and the protrusion member 198 according to the present embodiment has a semi-elliptical sphere shape. The protrusion member 198 covers the coupling member 194, and is coupled to an end portion located on the center side of the rotator 172 of each blade 196, without a gap.

A height dimension of the protrusion member 198 may be higher than a height dimension of each blade 196, and is substantially half a height of the side wall 180 in the present embodiment. The protrusion member 198 may be provided as needed and may be omitted.

The drive mechanism 174 is a member that rotationally drives the rotator 172, and is disposed below the mounting table 136. The drive mechanism 174 includes a stirring motor 210, a housing member 214, a drive shaft 216, and the coupling member 194. The housing member 214 is a cylinder-shaped housing for accommodating the drive shaft 216, and one end portion of the housing member 214 is coupled to a lower surface of the mounting table 136 to cover the bottom surface hole 183.

The drive shaft 216 is a rod-shaped member housed inside the housing member 214, and one end portion of the drive shaft 216 in a longitudinal direction is inserted into the bottom surface hole 183 and coupled to a lower surface of the rotating portion 190. A recess portion 218 that is recessed toward the other end portion is provided at the one end portion of the drive shaft 216 in the longitudinal direction. The recess portion 218 is formed so as to have substantially the same diameter as the center hole 191.

The drive shaft 216 is supported by the housing member 214 via two bearings 220. The other end portion of the drive shaft 216 in the longitudinal direction projects from the housing member 214, and is coupled to the stirring motor 210 via a coupling member 222. The stirring motor 210 is fixed to the mounting table 136 via the fixing member 224.

Next, the discharge pipe 132 will be described.

As illustrated in FIG. 5, the discharge pipe 132 is a tubular-shaped member having one end portion coupled to the outlet 189, and sends the sheet pieces MA2 stored in the case 170 to the measurement portion 134.

The discharge pipe 132 has a predetermined length dimension, and has a tubular shape with both ends open. One end portion of the discharge pipe 132 is rotatably coupled to the case 170, and the other end portion is located close to the measurement portion 134. In the present embodiment, the other end portion is located below the upper surface of the mounting table 136. That is, the discharge pipe 132 is provided to be inclined downward in a longitudinal direction, when seen in side view.

A spiral member 140 is disposed at an inner surface of the discharge pipe 132. The spiral member 140 is erected with a predetermined height dimension toward a center axis of the discharge pipe 132 in a longitudinal direction. A driven gear 142 is provided on an outer surface of the discharge pipe 132 over an entire circumferential direction.

A transport motor 150 is provided at a location adjacent to the discharge pipe 132. The transport motor 150 is attached to an upper surface of the support member 135 provided on a side surface of the mounting table 136. A disc-shaped drive gear 152 is provided at the transport motor 150. The drive gear 152 meshes with the driven gear 142. As a result, the discharge pipe 132 is rotationally driven in a circumferential direction by driving the transport motor 150.

The measurement portion 134 is located below the other end portion of the discharge pipe 132, is supported by a support table 138, and stores the sheet pieces MA2 discharged from the other end portion of the discharge pipe 132 until the sheet pieces MA2 reach a predetermined quantity. The measurement portion 134 includes a reception portion 160, a closing member 162, and a load cell 164.

The reception portion 160 is a box-shaped member configured to store a predetermined quantity of the sheet pieces MA2 inside, and an upper surface opening portion 166 is provided on an upper surface of the reception portion 160. The other end portion of the discharge pipe 132 is disposed above the upper surface opening portion 166. A lower surface opening portion 168 is provided on a lower surface of the reception portion 160.

A fixing portion 169 is provided on an outer surface of the reception portion 160. The fixing portion 169 projects outward from a predetermined location on the outer surface of the reception portion 160. The fixing portion 169 is fixed to the load cell 164 in a state in which a lower surface of the fixing portion 169 is in contact with an upper surface of the load cell 164.

The closing member 162 is a plate-shaped member that closes the lower surface opening portion 168. The closing member 162 is rotatably fixed to the reception portion 160. The closing member 162 is rotatable between a closing position for closing the lower surface opening portion 168 and an opening position for opening the lower surface opening portion 168.

The closing member 162 includes an opening and closing motor (not illustrated) of which operation is controlled by the control apparatus 110. The closing member 162 is driven by this opening and closing motor. Specifically, the closing member 162 is normally disposed at the closing position, and moves to the opening position when driven by the opening and closing motor. The closing member 162 may be configured to move to the closing position and the opening position by sliding such as a shutter.

The load cell 164 is a sensor that detects a force such as weight and torque, and outputs a predetermined signal according to the detected force. The load cell 164 is mounted and fixed to the support table 138.

In the present embodiment, the load cell 164 measures a weight of the reception portion 160, and outputs a predetermined signal to the control apparatus 110 when the reception portion 160 reaches a prescribed weight. Thus, the control apparatus 110 operates the opening and closing motor, and the closing member 162 moves from the closing position to the opening position.

The measurement portion 134 is not limited to the load cell 164, and another detector configured to detect the weight may be used.

### 2.2.2. Operation of Storage Portion

Next, a processing operation of the storage portion 13 according to the present embodiment will be described.

When the sheet manufacturing apparatus 100 is activated, the transport motor 150 and the stirring motor 210 are driven, and the rotator 172 and the discharge pipe 132 are rotationally driven.

When the sheet piece MA2 is put into the case 170 from the hopper 9, the sheet piece MA2 is stirred by the rotator 172. The sheet piece MA2 is wound around each blade 196, and is sent out in a peripheral direction of the rotator 172, that is, in a direction of the side wall 180, at the same time. By being stirred in this manner, even when a plurality of types of raw material sheets MA having different densities, thicknesses, colors, and the like are put into, it is possible to homogenize the raw material sheets MA inside the case 170, and to prevent the sheet pieces MA2 from becoming lumpy.

The stirred sheet pieces MA2 are sent out from the outlet 189 to the discharge pipe 132 by each blade 196. Inside the rotating discharge pipe 132, the sheet piece MA2 is sent out to the measurement portion 134 by the spiral member 140.

The sheet piece MA2 sent to the measurement portion 134 is put into the reception portion 160 through the upper surface opening portion 166. When a predetermined quantity of the sheet pieces MA2 are put into the reception portion 160 and the load cell 164 detects that the sheet pieces MA2 reach a prescribed quantity, the control apparatus 110 drives the opening and closing motor. As a result, the closing member 162 is rotated to move from the closing position to the opening position, and the sheet piece MA2 inside the reception portion 160 falls downward and is transported to the defibration portion 20.

The rotator 172 and the discharge pipe 132 can respectively rotate in opposite directions, stop the rotation, and change rotation speeds according to a processing state of the sheet manufacturing apparatus 100. By controlling such an operation, a discharge quantity of the sheet pieces MA2 by the discharge pipe 132 can be adjusted.

Further, these processing operations in the storage portion 13 are performed in the air, in the same manner as the defibration portion 20.

As described above, in the rotator 172, each blade 196 and the rotating portion 190, which form a part of the bottom surface 182, rotate integrally. As a result, it is possible to prevent the sheet piece MA2 from being compressed between each blade 196 and the bottom surface 182 to form a lump. Therefore, it is suppressed that the sheet piece MA2 stays inside the case 170 or the sheet pieces MA2 becoming lumpy are discharged, so that the stirring portion 130 can stably discharge a predetermined quantity of the sheet pieces MA2 from the outlet 189.

### 2.2.3. Case and Rotator

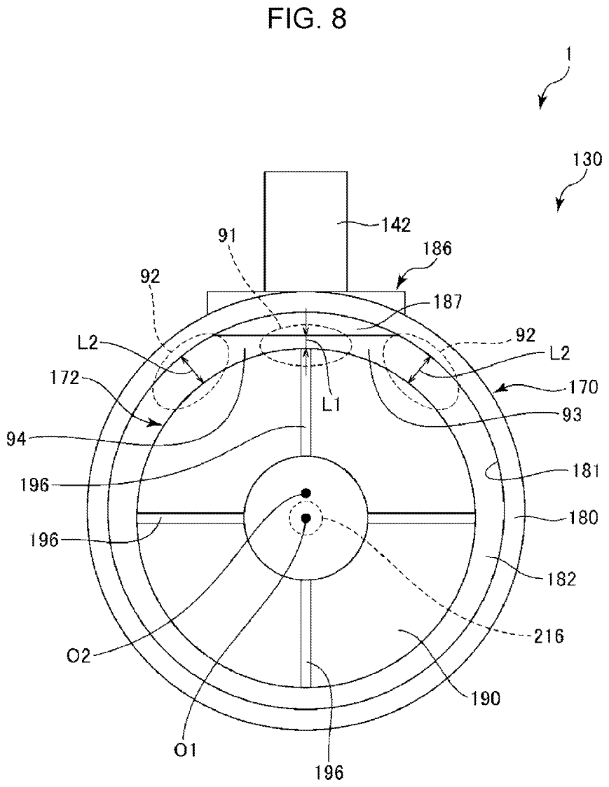

FIG. 8 is a plan view schematically illustrating the stirring portion 130 in FIG. 5.

As described above, the case 170 illustrated in FIG. 8 includes the bottom surface 182 and the inner surface 181. The drive shaft 216 is inserted through the bottom surface 182. The blade 196 of the rotator 172 is attached to the drive shaft 216.

As described above, in the present embodiment, the case 170 has a cylinder shape, so that the inner surface 181 of the case 170 when seen in top view has a perfect circular shape. On the other hand, in the present embodiment, an outer edge shape of the rotator 172 has also a perfect circular shape. Specifically, since the rotator 172 includes the rotating portion 190 having a disc shape and the four blades 196 arranged at the upper surface of the rotating portion 190, an outer edge shape of the rotating portion 190 as it is becomes the outer edge shape of the rotator 172.

In FIG. 8, a center 01 when seen in top view of the rotator 172 is disposed at a position different from a center O2 when seen in top view of the bottom surface 182. In FIG. 8, as described above, when the stirring portion 130 is seen in top view, each of a shape of the inner surface 181 of the case 170 and the outer edge shape of the rotator 172 has a perfect circular shape. Therefore, a non-uniform gap is generated between the inner surface 181 and the rotator 172.

Here, the shortest distance between the outer end of the blade 196 and the inner surface 181 in a radial direction of the rotator 172 is L1, and the longest distance is L2. Although not illustrated, an average major axis length of the sheet piece MA2 is L3. The stirring apparatus 1 according to the present embodiment is configured to satisfy a relationship of L1<L3<L2.

Specifically, in FIG. 8, the center 01 of the rotator 172 when seen in top view, that is, a position of the drive shaft 216 is disposed at a position different from the center O2 when seen in top view of the bottom surface 182. Such a positional relationship is called an offset. The inner wall member 187 is disposed so as to fill the gap widened by the offset. Therefore, a gap distance between the outer end of the blade 196 and the inner wall member 187 is the shortest distance L1. This portion in the case 170 is defined as a shortest portion 91. On the other hand, at each of two locations adjacent to the inner wall member 187 in a circumferential direction of the rotator 172, when the blade 196 moves, the distance between the outer end of the blade 196 and the inner surface 181 becomes the longest distance L2. This portion in the case 170 is referred to as a longest portion 92. Therefore, a distance of the longest portion 92 is L2 described above.

The distances L1 and L2 and the average major axis length L3 of the sheet piece MA2 accommodated in the case 170 satisfy a relationship of L1<L3<L2.

By satisfying such a relationship, in the stirring apparatus 1, the blade 196 alternately passes through the shortest portion 91 and the longest portion 92 described above. Thus, the sheet piece MA2 can be sufficiently stirred regardless of a quantity of the sheet pieces MA2.

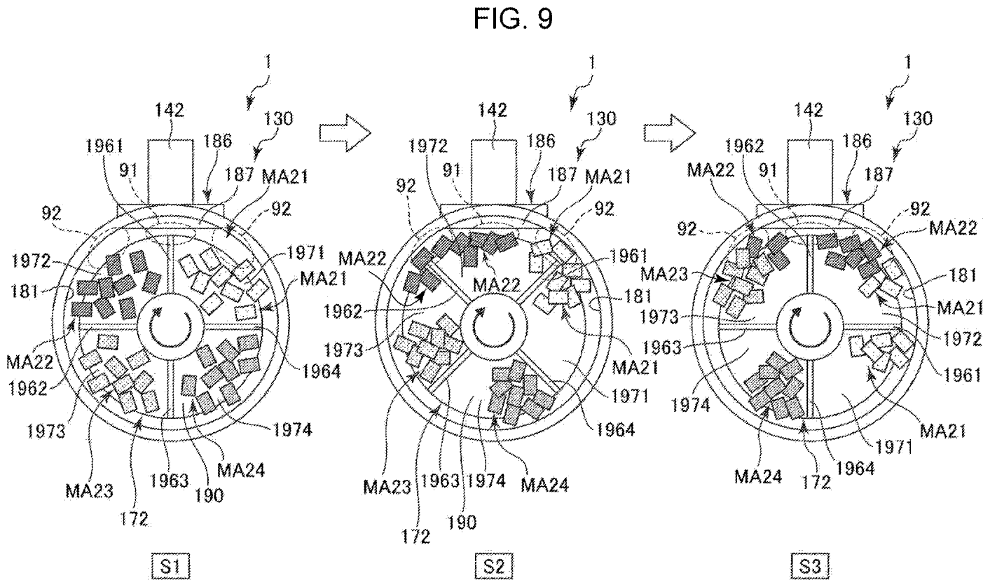

FIG. 9 is a schematic diagram illustrating a principle of stirring in the stirring portion 130 illustrated in FIG. 8. In FIG. 9, for convenience of description, a large number of sheet pieces MA2 accommodated in the case 170 are divided into four, from a first assemblage MA21 to a fourth assemblage MA24.

Further, in FIG. 9, the four blades 196 are a first blade 1961, a second blade 1962, a third blade 1963, and a fourth blade 1964. Further, in FIG. 9, a region between the first blade 1961 and the second blade 1962 is referred to as a first region 1971, a region between the second blade 1962 and the third blade 1963 is referred to as a second region 1972, a region between the third blade 1963 and the fourth blade 1964 is referred to as a third region 1973, and a region between the fourth blade 1964 and the first blade 1961 is referred to as a fourth region 1974.

A first state S1 in FIG. 9 is a state before a start of stirring. Therefore, in the first state S1, it is assumed that the first assemblage MA21 to the fourth assemblage MA24 are accommodated in the first region 1971 to the fourth region 1974 without being mixed with each other.

When the rotator 172 rotates clockwise and the first state S1 is shifted to a second state S2, the first blade 1961 moves from the shortest portion 91 to the longest portion 92. The first assemblage MA21 moves outward from the first region 1971 by centrifugal force, and is at a state of being easily moved in a circumferential direction via the longest portion 92 having a wide space. A sheet piece that moves together with the first blade 1961 and a sheet piece that the first blade 1961 does not reach are generated. As a result, there is a difference in moving speeds of the sheet pieces, and the slow-moving sheet piece moves so as to wrap around to an opposite side of the first blade 1961. As a result, the first assemblage MA21 is divided into both sides with the first blade 1961 in between.

Further, since the second blade 1962 also moves to the longest portion 92, the second assemblage MA22 is also at a state of being easily moved via the longest portion 92. Thus, a sheet piece that moves together with the second blade 1962 and a sheet piece that the second blade 1962 does not reach are generated. As a result, there is a difference in moving speeds of the sheet pieces, and the slow-moving sheet piece moves so as to wrap around to an opposite side of the second blade 1962. As a result, the second assemblage MA22 is also divided into both sides with the second blade 1962 in between.

On the other hand, in the shortest portion 91, the disc-shaped rotating portion 190 always forms a narrow gap with the inner surface 181. In the second state S2, since the second region 1972 moves to the shortest portion 91, a part of the second assemblage MA22 accommodated in the second region 1972 is compressed in this narrow gap. At this time, the lump can be unraveled by pressure.

At this time, the second assemblage MA22 passes through a distance changing portion 94 illustrated in FIG. 8 provided between the longest portion 92 and the shortest portion 91. The distance changing portion 94 is a portion set so that the distance between the outer end of the blade 196 and the inner surface 181 is continuously narrowed when the rotator 172 rotates clockwise. As the second assemblage MA22 passes through this portion, a compressive force is smoothly applied to the second assemblage MA22. Thus, the second assemblage MA22 can be compressed without being scattered.

When the second state S2 is shifted to the third state S3, a part of the first assemblage MA21 that moves to the second region 1972 is mixed with the second assemblage MA22 originally accommodated in the second region 1972. In this manner, the first assemblage MA21 and the second assemblage MA22 are stirred.

In the same manner, a part of the second assemblage MA22 that moves to the third region 1973 is mixed with the third assemblage MA23 originally accommodated in the third region 1973. In this manner, the second assemblage MA22 and the third assemblage MA23 are stirred.

Further, although not illustrated in the third state S3, the sheet piece MA2 is also compressed between the second blade 1962 that moves to the shortest portion 91 and the inner surface 181.

Further, when a part of the second assemblage MA22 compressed by the shortest portion 91 in the second state S2 moves to the longest portion 92 in the third state S3, the part is released from the compressed state and the sheet pieces MA2 can be easily separated from each other. Therefore, when the second blade 1962 moves to the longest portion 92 after the third state S3, the movement of wrapping around a back side of the second blade 1962 is promoted. As a result, the stirring between the second assemblage MA22 and the third assemblage MA23 is further promoted.

At this time, the second assemblage MA22 passes through a distance changing portion 93 illustrated in FIG. 8 provided between the shortest portion 91 and the longest portion 92. The distance changing portion 93 is a portion set so that the distance between the outer end of the blade 196 and the inner surface 181 is continuously widened when the rotator 172 rotates clockwise. By passing the second assemblage MA22 through this portion, a compressive force can be smoothly released from the second assemblage MA22. Thus, the sheet pieces MA2 can be separated from each other without scattering the second assemblage MA22.

After that, with the rotation of the rotator 172, states in the same manner as the second state S2 and the third state S3 repeatedly appear. Therefore, mixing of the third assemblage MA23 and the fourth assemblage MA24 and mixing of the fourth assemblage MA24 and the first assemblage MA21 are also performed.

As described above, in the stirring portion 130, the sheet piece MA2 is moved through the longest portion 92 and the sheet piece MA2 is compressed in the shortest portion 91. As a result, even when the quantity of the sheet pieces MA2 is small, it is possible to sufficiently stir the sheet pieces MA2.

Further, according to the above principle, a rate of the sheet pieces MA2 that stay is reduced even when the rotator 172 is rotated at a low speed. Therefore, the sufficient stirring can be performed without rotating at a high speed, and power consumption of the stirring apparatus 1 can be reduced.

Here, a stirring apparatus in the related art will be described. As the stirring apparatus in the related art, there is known an apparatus having a configuration in which a gap between the first blade 1961 and the inner surface 181 is made constant, and sheet pieces get over an upper part of the blade 196 instead of being moved via this gap. In order to get over the upper part of the blade 196 in this manner, it is necessary that a sufficient quantity of sheet pieces are accommodated in the case 170. Therefore, when the quantity of the sheet pieces accommodated in the case 170 is small, a quantity of the sheet pieces that cannot get over the blades 196 becomes large. As a result, there is a problem that stirring efficiency is lowered.

Further, when an average major axis length of the sheet piece is shorter than the gap, there is a problem that the sheet piece stays in the gap. On the other hand, when the average major axis length of the sheet piece is longer than the gap, it becomes difficult to pass through the gap, so that there is also a problem that the stirring efficiency is lowered in this case as well.

Therefore, the present inventor has made extensive studies on measures to solve these problems. When a predetermined relationship is established between the distance L1 of the shortest portion 91 and the distance L2 of the longest portion 92 and the average major axis length L3 of the sheet piece MA2, it is found that sufficient stirring is possible even with a small amount, and the present disclosure is completed.

Specifically, in the present embodiment, the average major axis length L3 of the sheet piece MA2 is set to be between the distance L1 and the distance L2. That is, a relationship between the configuration of the stirring portion 130 defined by the distances L1 and L2 and a shape of the sheet piece MA2 prescribed by the average major axis length L3 is optimized.

Thus, the sheet piece MA2 can repeatedly have a movement of being compressed at the shortest portion 91 of the distance L1 and being released from the pressure at the longest portion 92 of the distance L2. Therefore, sufficient stirring efficiency can be obtained without rotating the rotator 172 at a high speed. Further, even when the quantity of the sheet pieces MA2 accommodated in the case 170 is small, it is possible to sufficiently stir the sheet pieces MA2. Further, it is possible to prevent the sheet pieces MA2 from becoming lumpy, and to stably discharge the sheet piece MA2 in a state configured to be appropriately processed in the next step, from the outlet 189.

When the average major axis length L3 is equal to or less than the distance L1, the average major axis length L3 is too short, so that the sheet piece MA2 is less likely to be compressed by the shortest portion 91. In addition, the lump of the sheet pieces MA2 cannot be sufficiently unraveled, in some cases. Further, a movement that the sheet piece MA2 wraps around a back side of the blade 196 is less likely to occur. Therefore, the sheet piece MA2 tends to stay on the inner surface 181 and the stirring efficiency is lowered. On the other hand, when the average major axis length L3 is equal to or more than the distance L2, the sheet piece MA2 is less likely to pass through even the longest portion 92. Therefore, a movement quantity of the sheet piece MA2 is reduced. As a result, the mixing of the sheet piece MA2 is reduced, and the stirring efficiency is lowered.

The average major axis length L3 of the sheet piece MA2 is obtained as following.

First, the 10 sheet pieces MA2 accommodated in the case 170 are freely extracted and projected onto a planar surface. A length of the longest line segment that can be taken in the projected image is defined as a major axis. The 10 major axes are obtained, and an average value of the 10 major axes is defined as the average major axis length L3. When the number of sheet pieces MA2 accommodated in the case 170 is less than 10, the major axis is measured for all the sheet pieces MA2, and the average value is taken as the average major axis length L3.

As described above, the stirring apparatus 1 according to the present embodiment includes the shredder 12, the case 170 having the bottom surface 182 and the inner surface 181, and the rotator 172. The shredder 12 shreds the raw material sheet MA. The case 170 accommodates the sheet pieces MA2 shredded by the shredder 12. The rotator 172 is disposed at the bottom surface 182 of the case 170, and includes the blade 196 that stirs the sheet piece MA2 by rotation.

Between the outer end of the blade 196 and the inner surface 181 in the radial direction of the rotator 172, the shortest distance L1 in the radial direction, the longest distance L2 in the radial direction, and the average major axis length L3 of the sheet piece MA2 satisfy L1<L3<L2.

Such a stirring apparatus 1 can sufficiently stir the sheet pieces MA2 stored in the case 170, which is a storage container. Thus, the sheet piece MA2 in the state configured to be appropriately processible in the next step can be stably discharged from the outlet 189.

Further, in the stirring apparatus 1, regardless of the quantity of the sheet pieces MA2, in other words, even when the quantity of the sheet pieces MA2 is small, the stirring can be sufficiently performed. Therefore, the quantity of the sheet pieces MA2 can be suppressed, and it is not necessary to increase a height of the case 170 more than necessary. Therefore, a size of the storage portion 13 can be reduced.

Further, in the stirring apparatus 1, even when a rotation speed of the rotator 172 is lowered, the stirring efficiency is less likely to decrease. Therefore, power saving of the stirring apparatus 1 can be achieved. In other words, even when a peripheral speed of the rotator 172 is lowered, the stirring efficiency is less likely to be lowered, so that the size of the storage portion 13 can be increased while maintaining the rotation speed and suppressing the power consumption.

Further, the stirring method according to the present embodiment is a method of stirring the sheet piece MA2 using the apparatus including the case 170 having the bottom surface 182 and the inner surface 181, and the rotator 172 having the blade 196. In this method, between the outer end of the blade 196 and the inner surface 181 in the radial direction of the rotator 172, the shortest distance L1 in the radial direction, the longest distance L2 in the radial direction, and the average major axis length L3 of the sheet piece MA2 satisfy L1<L3<L2.

According to such a stirring method, even when the quantity of the sheet pieces MA2 is small, the sheet piece MA2 stored in the case 170 can be sufficiently stirred. Thus, the sheet piece MA2 in the state configured to be appropriately processible in the next step can be obtained.

Further, the shredder 12 includes the first cutting portion 15A that cuts the raw material sheet MA into the strip piece MA1 having the width La, and the second cutting portion 15B that cuts the strip piece MA1 into the sheet piece MA2 having the length Lb. The stirring apparatus 1 including the shredder 12 and the storage portion 13 satisfies L1<(La²+Lb²)^{0.5}<L2.

The sheet piece MA2 formed by the shredder 12 as described above has a substantially rectangular shape having the width La and the length Lb. Therefore, the major axis of such a sheet piece MA2 is a length of the diagonal line. The length of the diagonal line is calculated by (La²+Lb²)^{0.5} by the three-square theorem. Therefore, when the stirring apparatus 1 satisfies L1<(La²+Lb²)^{0.5}<L2, as a result, L1<L3<L2 is satisfied described above. Therefore, the stirring apparatus 1 satisfying L1<(La²+Lb²)^{0.5}<L2 can sufficiently stir the sheet piece MA2 stored in the case 170, which is a storage container, even when the quantity of the sheet pieces MA2 is small.

Further, the rotator 172 has the drive shaft 216 disposed at the bottom surface 182 of the case 170 and the blade 196 attached to the drive shaft 216. The positions of the center of the bottom surface 182 and the drive shaft 216 are different from each other. By setting such an offset, even when both the outer edge shape of the rotator 172 and the shape of the inner surface 181 of the case 170 are perfect circular shapes, the shortest portion 91 and the longest portion 92 described above can be easily formed. Therefore, it is possible to realize the stirring apparatus 1 that is easily manufactured.

Further, in the present embodiment, the stirring apparatus 1 includes the inner wall member 187. The inner wall member 187 is provided in the gap widened by the offset. A position at which the inner wall member 187 is provided is not particularly limited, and may be provided in a direction from the center of the bottom surface 182 toward the inner surface 181, that is, a direction other than a direction from the center of the bottom surface 182 toward the drive shaft 216, among all directions from the center of the bottom surface 182, that is, may be provided on the inner surface 181 located in a direction other than an offset direction of the drive shaft 216. In the present embodiment, as an example of this direction, the inner wall member 187 is provided on the side opposite to the offset direction, that is, on the inner surface 181 of a lower part in FIG. 8.

By providing the inner wall member 187 at such a position, the shortest portion 91 described above can be formed even in the gap widened by the offset. That is, the shortest portion 91 can be added by appropriately adding the inner wall member 187. Thus, a desired number of the shortest portions 91 can be arranged at desired positions, and the sheet pieces MA2 can be stirred more efficiently. It is also useful in that the shortest portion 91 can be added or moved hereafter.

Further, the stirring apparatus 1 according to the present embodiment includes the discharge pipe 132 which is a tubular body that communicates with the inside and the outside of the case 170. The discharge pipe 132 is coupled to the inner surface 181 opposite to a direction from the center of the bottom surface 182 toward the drive shaft 216.

Thus, the space between the rotator 172 and the discharge pipe 132 is not too narrow, and a certain amount of gap is provided. That is, it is possible to prevent the sheet piece MA2 from staying in the narrow gap. Thus, the sheet piece MA2 is allowed to move in the vicinity of the coupled portion of the discharge pipe 132. As a result, with the rotation of the rotator 172, it is possible to promote the movement of sending the sheet piece MA2 to the discharge pipe 132, and it is possible to more stably supply the sheet piece MA2.

Further, the stirring apparatus 1 according to the present embodiment includes the portion at which the distance between the outer end of the blade 196 and the inner surface 181 in the radial direction of the rotator 172 changes continuously in the circumferential direction of the rotator 172. Specifically, the distance changing portion 93 illustrated in FIG. 8 is set so that the distance between the outer end of the blade 196 and the inner surface 181 is continuously widened when the rotator 172 rotates clockwise. On the other hand, the distance changing portion 94 illustrated in FIG. 8 is set so that the distance between the outer end of the blade 196 and the inner surface 181 is continuously narrowed when the rotator 172 rotates clockwise.

By providing such distance changing portions 93 and 94, the sheet piece MA2 can be smoothly compressed and released, and it is possible to suppress the sheet piece MA2 from staying.

The continuous change means, for example, a state in which the distance changes according to a curvature or the like of the outer edge of the rotator 172, as illustrated in FIG. 8. Therefore, for example, a projection object or the like projecting from the inner surface 181 does not correspond to the portion at which the distance is continuously changed. Such a portion at which the distance changes discontinuously obstructs the flow of the sheet piece MA2, and thus the sheet piece MA2 easily stays.

Further, the rotator 172 according to the present embodiment has the plate-shaped rotating portion 190 expanding along the bottom surface 182. The blade 196 is provided so as to be erected on the rotating portion 190.

According to such a configuration, it is possible to prevent the sheet piece MA2 from being compressed between the blade 196 and the bottom surface 182 and becoming lumpy. Thus, the sheet piece MA2 can be sufficiently stirred and can be supplied more stably. Further, a pressure change by not only the blade 196 but also a change in the distance between the rotating portion 190 and the inner surface 181 can be applied to the sheet piece MA2. Thus, the sheet pieces MA2 can be sufficiently stirred while being unraveled, and the homogeneity of the sheet piece MA2 after stirring can be improved.

The distance L1, the distance L2, and the average major axis length L3 of the sheet piece MA2 may satisfy L1<L3<L2 described above, and may satisfy L2<(3×L3). That is, L1<L3<L2<(3×L3) may be satisfied.

According to such a configuration, it is possible to suppress the adverse effect that the distance L2 is too wide. When the distance L2 is too wide, there is a space that is not affected by the rotator 172, so the sheet piece MA2 may stay in the space. Therefore, by setting the upper limit value for the distance L2, it is possible to suppress the occurrence of such an adverse effect, and to further improve the stirring efficiency.

On the other hand, the relationship between the distance L1 and the distance L2 may be such that L1<L2 is satisfied, and may be more appropriately (1.5×L1)<L2<(100×L1). Thus, the compression and release described above sufficiently act on the sheet pieces MA2. That is, since a difference in pressure between compression and release becomes sufficiently large, the stirring efficiency can be further improved.

A size of the sheet piece MA2 is not particularly limited, and for example, the average major axis length L3 is equal to or more than 5 mm and is equal to or less than 50 mm. As a more specific example, when the distance L1 is 10 mm, the distance L2 is 40 mm, and the average major axis length L3 of the sheet piece MA2 is 20 mm.

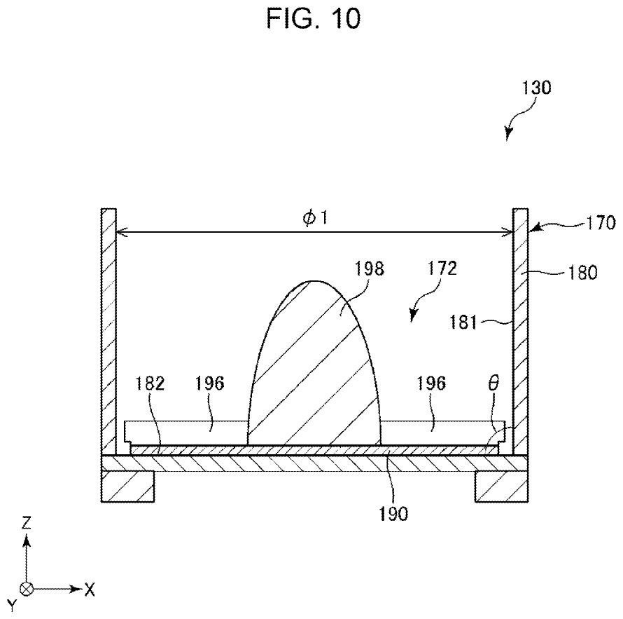

FIG. 10 is a schematic view illustrating a longitudinal cross-section of the stirring portion 130 illustrated in FIG. 8. In FIG. 10, an X-axis, a Y-axis, and a Z-axis that are orthogonal to each other are set. The bottom surface 182 is a plane parallel to the XY plane.

As illustrated in FIG. 10, the case 170 has a constant diameter φ1 on the inner surface 181 in the Z-axis direction. In this case, the manufacturing or maintenance for the stirring portion 130 becomes easy.

In the above case, an angle θ formed by the bottom surface 182 and the inner surface 181 is 90°. Meanwhile, the angle may not be 90° over the entire circumference of the inner surface 181, and may be other than 90° in part.

On the other hand, although not illustrated, the diameter φ1 may be changed in the Z-axis direction. As an example, the stirring portion 130 may be configured so that the diameter φ1 decreases in the +Z-axis direction. In this case, even when the sheet piece MA2 rises in the +Z-axis direction with the rotation of the rotator 172, the sheet piece MA2 rises along the inner surface 181, so that the sheet piece MA2 falls on the rotator 172 when the sheet piece MA2 rises to some extent. Therefore, the sheet piece MA2 can be stirred even in the Z-axis direction, and the stirring efficiency can be further improved.

### 3. Modification Example

Next, a modification example of the stirring apparatus according to the embodiment will be described.

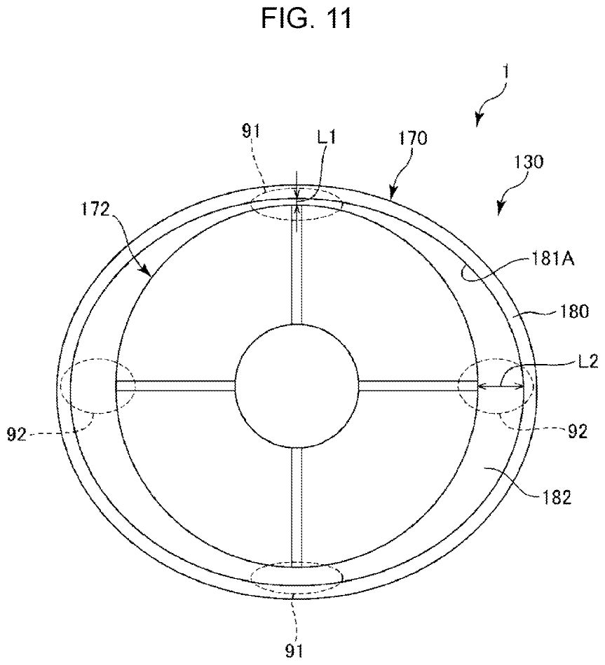

FIG. 11 is a plan view illustrating a storage portion of a stirring apparatus according to a first modification example.

Hereinafter, the first modification example will be described, and in the following description, a difference from the embodiment described above will be mainly described and description of the same matters will be omitted. In FIG. 11, the same components as those in the embodiments are denoted by the same reference numerals.

In the stirring portion 130 of the stirring apparatus 1 illustrated in FIG. 11, a horizontal cross-section of an inner surface 181A of the case 170 has an elliptical shape. On the other hand, an outer edge shape of the rotator 172 is a perfect circular shape.

Further, in the stirring portion 130 illustrated in FIG. 11, a center of the rotator 172 when seen in top view, that is, a position of the drive shaft 216 overlaps with a center of the bottom surface 182 when seen in top view. That is, an offset is not set in the stirring portion 130 illustrated in FIG. 11.

As described above, although the stirring portion 130 is not offset, shapes of the inner surface 181A and the outer edge of the rotator 172 are different from each other, so that the shortest portion 91 and the longest portion 92 described above are formed. Therefore, when L1<L3<L2 is established between the distances L1 and L2 and the average major axis length L3 of the sheet piece MA2 described above, the same effect as that of the embodiment can be obtained.

Further, the stirring portion 130 illustrated in FIG. 11 includes the two shortest portions 91 and the two longest portions 92. Between the distance L1 and the distance L2, a distance between an outer end of the blade 196 and the inner surface 181A in a radial direction of the rotator 172 is continuously (smoothly) changed. Therefore, the sheet piece MA2 is likely to be suppressed from staying.

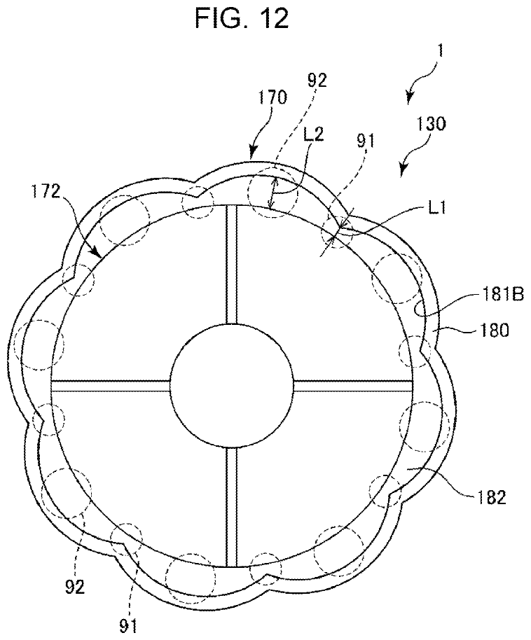

FIG. 12 is a plan view illustrating a storage portion of a stirring apparatus according to a second modification example.

Hereinafter, the second modification example will be described, and in the following description, a difference from the embodiment described above will be mainly described and description of the same matters will be omitted. In FIG. 12, the same components as those in the embodiments are denoted by the same reference numerals.

In the stirring portion 130 of the stirring apparatus 1 illustrated in FIG. 12, a horizontal cross-section of an inner surface 181B of the case 170 has a wavy shape. The wavy shape is a shape in which arcs with different centers are coupled to form an annular shape. On the other hand, an outer edge shape of the rotator 172 is a perfect circular shape.

Further, in the stirring portion 130 illustrated in FIG. 12, a center of the rotator 172 when seen in top view, that is, a position of the drive shaft 216 overlaps with a center of the bottom surface 182 when seen in top view. That is, an offset is not set in the stirring portion 130 illustrated in FIG. 12.

As described above, although the stirring portion 130 is not offset, shapes of the inner surface 181B and the outer edge of the rotator 172 are different from each other, so that the shortest portion 91 and the longest portion 92 described above are formed. Therefore, when L1<L3<L2 is established between the distances L1 and L2 and the average major axis length L3 of the sheet piece MA2 described above, the same effect as that of the embodiment can be obtained.

Further, the stirring portion 130 illustrated in FIG. 12 includes the three or more shortest portions 91 and the three or more longest portions 92. Therefore, while the rotator 172 makes one rotation, the respective sheet pieces MA2 are compressed and released a plurality of times, and the stirring efficiency can be particularly improved.

As described above, in the stirring apparatus 1 according to the present modification example, a horizontal cross-section of the inner surface 181 of the case 170 has an elliptical shape or a wavy shape.

According to such a configuration, the shortest portion 91 and the longest portion 92 can be formed without setting an offset. Therefore, the manufacturing of the stirring apparatus 1 becomes easy.

Even in the modification examples as described above, the same effect as that of the embodiment can be obtained.

In the above modification example, the inner surface 181 has an elliptical shape or a wavy shape, meanwhile, the outer edge shape of the rotator 172 may have an elliptical shape or a wavy shape, and the inner surface 181 may have a perfect circular shape.

Further, the shape of the inner surface 181 is not limited to each of the above shapes, and may be, for example, a polygon shape such as a hexagon or an octagon, an oval shape, or another shape.

In the same manner, the outer edge shape of the rotator 172 is not limited to each of the above shapes, and may be, for example, a polygon shape such as a hexagon or an octagon, an oval shape, or another shape.

Hereinbefore, the stirring apparatus and the stirring method according to the present disclosure are described based on the embodiments illustrated in the accompanying drawings, but the present disclosure is not limited thereto and each portion constituting the stirring apparatus can be replaced with each portion of any configuration having the same function. Further, any component may be added to the present disclosure.

In addition, with the stirring method according to the present disclosure, it is also possible to stir a sheet piece other than the sheet piece produced in the shredder according to the embodiment.

What is claimed is:

1. A stirring apparatus comprising:
a shredder that shreds a sheet;
a case that accommodates a sheet piece shredded by the shredder and has a bottom surface and an inner surface; and
a rotator that is disposed at the bottom surface of the case and includes a blade which stirs the sheet piece by rotation, wherein
L1<L3<L2, when between an outer end of the blade and the inner surface in a radial direction of the rotator, a shortest distance in the radial direction is defined as L1, a longest distance in the radial direction is defined as L2, and an average major axis length of the sheet piece is defined as L3.

2. The stirring apparatus according to claim 1, wherein
the shredder includes
a first cutting portion that cuts the sheet into strip pieces having a width La, and
a second cutting portion that cuts the strip piece into sheet pieces having a length Lb, and
L1<(La²+Lb²)^{0.5}<L2.

3. The stirring apparatus according to claim 1, wherein
the rotator includes a drive shaft disposed at the bottom surface and the blade attached to the drive shaft, and
a center of the bottom surface and the drive shaft are located at different positions from each other.

4. The stirring apparatus according to claim 3, further comprising:
an inner wall member located in a direction other than a direction toward the drive shaft, among directions from the center of the bottom surface toward the inner surface, and attached to the inner surface.

5. The stirring apparatus according to claim 3, further comprising:
a tubular body that communicates with an inside and an outside of the case, wherein
the tubular body is coupled to the inner surface on a side opposite to a direction from the center of the bottom surface toward the drive shaft.

6. The stirring apparatus according to claim 1, wherein
a distance between the outer end of the blade and the inner surface in the radial direction of the rotator is continuously changed in a circumferential direction of the rotator.

7. The stirring apparatus according to claim 1, wherein
the rotator includes a plate-shaped rotating portion that expands along the bottom surface, and
the blade is erected on the rotating portion.

8. The stirring apparatus according to claim 1, wherein
a horizontal cross-section of the inner surface of the case has an elliptical shape or a wavy shape.

9. The stirring apparatus according to claim 1, wherein
the distance L2 and the average major axis length L3 satisfy L2<(3×L3).

10. A stirring method of stirring a sheet piece by using an apparatus including a case that accommodates the sheet piece and has a bottom surface and an inner surface; and a rotator that is disposed at the bottom surface of the case and includes a blade, wherein
L1<L3<L2, when between an outer end of the blade and the inner surface in a radial direction of the rotator, a shortest distance in the radial direction is defined as L1, a longest distance in the radial direction is defined as L2, and an average major axis length of the sheet piece is defined as L3.
